(19) United States
(12) Patent Application Publication
(10) Pub. No.: US 2026/0005532 A1
(43) Pub. Date: Jan. 1, 2026

(54) POWER TOOL SYSTEM AND ADAPTER

(71) Applicant: Nanjing Chervon Industry Co., Ltd., Nanjing (CN)

(72) Inventors: Shuang Li, Nanjing (CN); Huaishu Wang, Nanjing (CN); Dong Yang, Nanjing (CN)

(21) Appl. No.: 19/220,734

(22) Filed: May 28, 2025

(30) Foreign Application Priority Data
Jun. 28, 2024 (CN) 202410865053.3

(51) Int. Cl. H02J 7/00; H02M 1/00; H02M 1/36

(52) U.S. Cl. CPC H02J 7/0063; H02J 7/0047; H02M 1/0009; H02M 1/36; H02J 2310/22

(57) ABSTRACT

A power tool system includes a power tool having a motor, a battery pack, and an adapter. The battery pack is capable of outputting a voltage different from the rated voltage of the power tool to start the power tool. The adapter includes a first port connected to the battery pack and used for accessing a first voltage outputted by the battery pack; a second port connected to the power tool and used for outputting a second voltage; and a voltage conversion unit for converting the first voltage into the second voltage. The voltage conversion unit includes a switch unit connected between the first port and the second port; a capacitor connected in parallel to the second port; and a control unit configured to set the switching frequency or the switching duty cycle of the switch unit based on the parameter related to the current of the motor.

### RELATED APPLICATION INFORMATION

This application claims the benefit under 35 U.S.C. § 119(a) of Chinese Patent Application No. 202410865053.3, filed on Jun. 28, 2024, which application is incorporated herein by reference in its entirety.

### TECHNICAL FIELD

The present application relates to the technical field of tools and, in particular, to a power tool system and an adapter.

### BACKGROUND

The power tool is more environmentally friendly than the engine tool and is therefore widely used. Generally, the motor drives the power tool to work. The power tool is powered by the battery pack. Power tools of different specifications require battery packs with different output voltages so that the power tools can work normally.

To broaden the applicability of the battery pack, an adapter may be connected between the power tool and the battery pack, and the adapter can boost or buck the output voltage of the battery pack so that the battery pack can match the power tool. When the adapter boosts or bucks the voltage, the electronic components inside the adapter generate heat. Sometimes, the electronic components generate heat severely, causing the temperature rise result of the adapter to exceed the standard. In this case, the temperature rise result does not satisfy the temperature rise requirement.

This part provides background information related to the present application, and the background information is not necessarily the existing art.

### SUMMARY

A power tool system includes a power tool having a motor, a battery pack, and an adapter electrically connected between the power tool and the battery pack. The battery pack is configured to be capable of outputting a voltage different from the rated voltage of the power tool to start the power tool. The adapter includes a first port electrically connected to the battery pack and used for accessing a first voltage outputted by the battery pack; a second port electrically connected to the power tool and used for outputting a second voltage; and a voltage conversion unit for converting the first voltage into the second voltage. The voltage conversion unit further includes a switch unit connected between the first port and the second port; a capacitor connected in parallel to the second port; and a control unit configured to set the switching frequency or the switching duty cycle of the switch unit based on at least the parameter related to the current of the motor.

In some examples, the power tool system further includes a current detection unit for detecting the bus current of the motor, where the control unit sets the switching duty cycle to 1 when detecting that the bus current is greater than or equal to a preset current threshold.

In some examples, the current detection unit is further used for detecting the operating current of the motor, and a corresponding conversion relationship exists between the operating current and the bus current.

In some examples, the preset current threshold is approximately 17 A.

In some examples, the parameter includes I_{bus}, R, and K, where I_{bus} denotes the bus current of the motor, R denotes loop impedance, and K denotes a constant greater than 0.

In some examples, the control unit further includes a correction unit, where the correction unit acquires the parameter and outputs a correction value to correct a reference voltage, and the correction value includes the current compensation feedback I_{bus}*R*K.

In some examples, the loop impedance is the impedance of a loop between the battery pack and the motor of the power tool.

In some examples, the control unit is configured to set the switching duty cycle based on the difference between the sum of the current compensation feedback and the reference voltage and the current second voltage such that the second voltage is basically the same as the sum.

In some examples, the second voltage varies with the bus current.

In some examples, the first voltage is greater than the second voltage, and the second voltage is greater than the rated voltage of the power tool.

In some examples, the capacitance value of the capacitor is greater than or equal to 470 μF*2 and less than or equal to 680 μF*4.

In some examples, the switch unit is a metal-oxide-semiconductor (MOS) transistor or a triode.

In some examples, the control unit includes a control module, and the control module is a proportional-integral (PI) control module.

In some examples, the power tool system further includes a power-on switch unit, where when the power-on switch unit is turned on, the adapter is powered on to charge the capacitor.

In some examples, a resistor is connected in parallel across two ends of the switch unit to keep the capacitor in a charged state.

In some examples, a power tool system includes a power tool having a motor, a battery pack, and an adapter electrically connected between the power tool and the battery pack. The battery pack is configured to output a voltage different from the rated voltage of the power tool to start the power tool. The adapter includes a first port electrically connectable to the battery pack and used for accessing a first voltage outputted by the battery pack; a second port electrically connectable to the power tool and used for outputting a second voltage; and a voltage conversion unit for converting the first voltage into the second voltage to supply power to the power tool. The voltage conversion unit further includes a switch unit connected between the first port and the second port; and a control unit having a first input terminal for accessing a reference voltage, a second input terminal for accessing the second voltage, and an output terminal connected to the switch unit. The control unit further includes a correction unit for acquiring a parameter output correction value of the motor to correct the reference voltage. The control unit is configured to adjust the switching duty cycle of the switch unit based on the corrected reference voltage and the second voltage.

In some examples, an adapter includes a first port electrically connectable to a battery pack and used for accessing a first voltage outputted by the battery pack; a second port electrically connectable to a power tool and used for outputting a second voltage to supply power to a motor of the power tool; and a voltage conversion unit for converting the first voltage into the second voltage, where the first voltage is greater than or equal to the second voltage. The voltage conversion unit further includes a switch unit connected between the first port and the second port; and a control unit configured to set the switching duty cycle of the switch unit to 1 when the current of the motor reaches a preset current threshold and set the switching duty cycle of the switch unit to be less than 1 when the current of the motor is less than the preset current threshold.

In some examples, the preset current threshold is approximately 17 A.

In some examples, the control unit further includes a correction unit, the correction unit acquires a parameter of the motor and outputs a correction value to correct a reference voltage, and the correction value includes the current compensation feedback I_{bus}*R*K, where I_{bus} denotes the bus current of the motor, R denotes loop impedance, and K denotes a constant greater than 0.

In some examples, when the current of the motor is less than the preset current threshold, the control unit is configured to set the switching duty cycle based on the difference between the sum of the current compensation feedback and the reference voltage and the current second voltage such that the second voltage is basically the same as the sum.

### BRIEF DESCRIPTION OF THE DRAWINGS

FIG. 1 is a perspective view of a battery pack and power tools according to an example.

FIG. 2 is a perspective view of a power tool system according to an example.

FIG. 3 is a schematic diagram illustrating the circuit connection of the power tool system in FIG. 2.

FIG. 4 is a schematic diagram of a circuit inside a control unit in FIG. 3.

FIG. 5 is a schematic diagram illustrating the connection and a power-on circuit of a power tool system according to an example.

FIG. 6 is a schematic diagram illustrating that a power tool system includes a parallel circuit according to an example.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

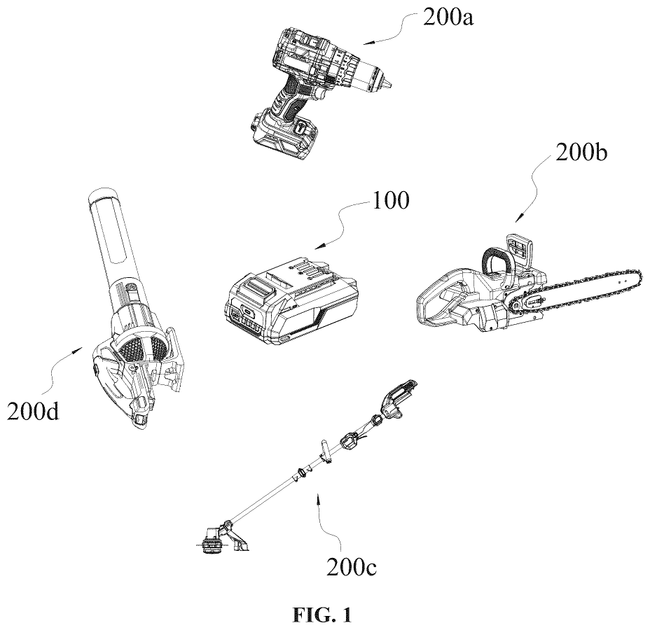

In this example, various power tools 200 can be powered by a battery pack 100. FIG. 1 illustrates several common power tools, such as an electric drill 200a, a chainsaw 200b, a string trimmer 200c, and a blower 200d. It is to be noted that the power tool 200 may be a handheld power tool, such as a drill, a hedge trimmer, or a sander. Alternatively, the power tool 200 may be a table tool, such as a table saw or a miter saw. Alternatively, the power tool 200 may be a push power tool, such as a push mower or a push snow thrower. Alternatively, the power tool 200 may be a riding power tool, such as a riding mower, a riding vehicle, or an all-terrain vehicle. Alternatively, the power tool 200 may be a robotic tool, such as a robotic mower or a robotic snow thrower. In some examples, the power tool 200 may be an electric drill, an electric lamp, an electric vehicle, or the like. In some examples, the power tool 200 may be a garden tool, such as a hedge trimmer, a blower, a mower, or a chainsaw. Alternatively, the power tool 200 may be a decorating tool, such as a screwdriver, a nail gun, a circular saw, or a sander. In some examples, the power tool 200 may be a vegetation care tool, such as a string trimmer, a mower, a hedge trimmer, or a chainsaw. Alternatively, the power tool 200 may be a cleaning tool, such as a blower, a snow thrower, or a cleaning machine. Alternatively, the power tool 200 may be a drilling tool, such as a drill, a screwdriver, a wrench, or an electric hammer. Alternatively, the power tool 200 may be a sawing tool, such as a reciprocating saw, a jigsaw, or a circular saw. Alternatively, the power tool 200 may be a table tool, such as a table saw, a miter saw, a metal cutter, or an electric router. Alternatively, the power tool 200 may be a sanding tool, such as an angle grinder or a sander.

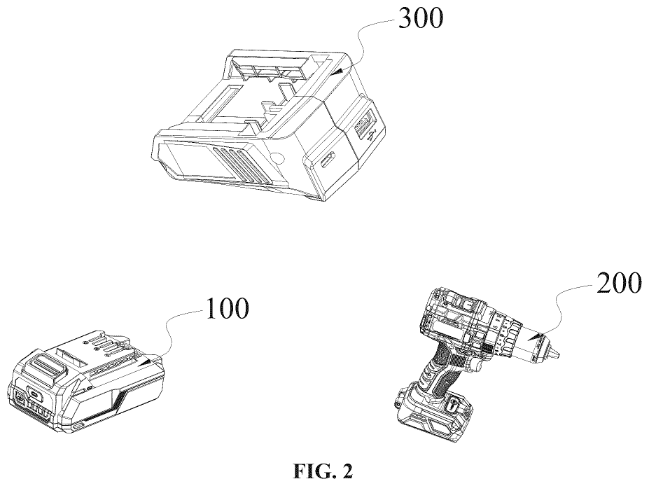

As shown in FIG. 2, a power tool system includes the battery pack 100, the power tool 200 (the electric drill 200a is used as an example), and an adapter 300. The adapter 300 is used to be connected between the battery pack 100 and the power tool 200. In this manner, when the battery pack 100 outputs a voltage different from the rated voltage of the power tool 200, the adapter 300 can convert the voltage outputted by the battery pack 100 into the voltage required by the power tool 200 to start the power tool 200. In addition, in some examples, based on the adapter 300, the battery pack 100 may also supply power to non-power tools with different rated voltages, such as a lamp.

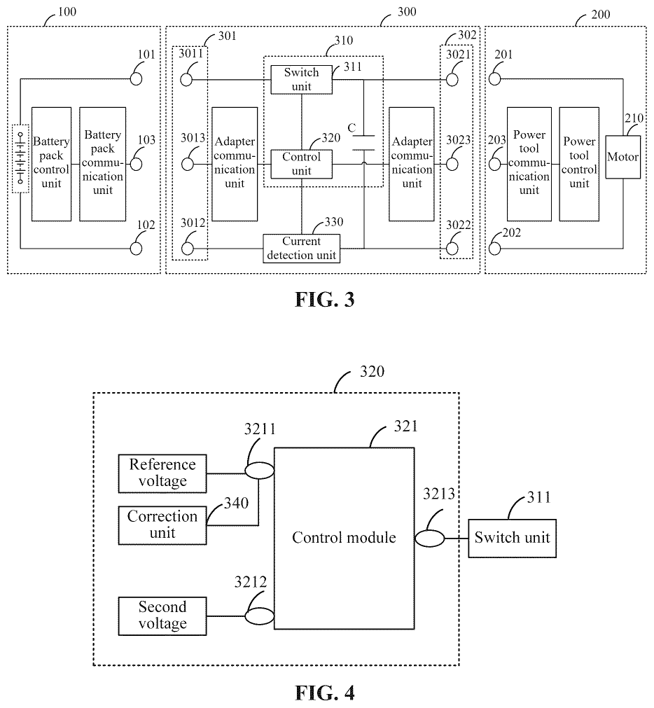

As shown in FIG. 3, the adapter 300 includes a first port 301 and a second port 302. The first port 301 is electrically connectable to the battery pack 100, and the first port 301 is used for accessing a first voltage outputted by the battery pack 100. Specifically, the first port 301 includes a positive electrode port 3011 and a negative electrode port 3012. The positive electrode port 3011 is electrically connected to a positive electrode port 101 of the battery pack 100, and the negative electrode port 3012 is electrically connected to a negative electrode port 102 of the battery pack 100. The second port 302 is electrically connectable to the power tool 200, and the second port 302 is used for outputting a second voltage. Specifically, the second port 302 includes a positive electrode port 3021 and a negative electrode port 3022. The positive electrode port 3021 is electrically connected to a positive electrode port 201 of the power tool 200, and the negative electrode port 3022 is electrically connected to a negative electrode port 202 of the power tool 200. The adapter 300 further includes an adapter communication unit and a communication port, and the communication port includes a first communication port 3013 and a second communication port 3023. The first communication port 3013 is electrically connected to a communication port 103 of the battery pack 100, and the second communication port 3023 is electrically connected to a communication port 203 of the power tool 200.

Based on the electrical connection between the first communication port 3013 and the communication port 103 of the battery pack 100, the adapter communication unit of the adapter 300 can transmit information bidirectionally with a battery pack communication unit of the battery pack 100, and a battery pack control unit of the battery pack 100 controls the battery pack communication unit to transmit information bidirectionally with the adapter communication unit of the adapter 300. Optionally, the information about the battery pack 100 transmitted by the battery pack communication unit includes information such as the voltage of the battery pack 100. Based on the electrical connection between the second communication port 3023 and the communication port 203 of the power tool 200, the adapter communication unit of the adapter 300 can transmit information bidirectionally with a power tool communication unit of the power tool 200, and a power tool control unit of the power tool 200 controls the power tool communication unit to transmit information bidirectionally with the adapter communication unit of the adapter 300.

The adapter 300 further includes a voltage conversion unit 310 for converting the first voltage outputted by the battery pack 100 into the second voltage outputted by the second port 302. In this example, the output voltage of the battery pack 100 is much greater than the rated voltage of the power tool 200. To prevent the maximum rotational speed of the power tool 200 from exceeding the maximum nominal rated rotational speed too much, the adapter 300 bucks the first voltage outputted by the battery pack 100 and outputs the second voltage so that the rotational speed of the power tool 200 is within a suitable range. Optionally, the second voltage outputted by the second port 302 may be slightly greater than the rated voltage of the power tool 200. Optionally, the second voltage outputted by the second port 302 may be equal to the rated voltage of the power tool 200.

In some examples, the first voltage may be greater than the second voltage, and the second voltage may be greater than the rated voltage of the power tool 200. For example, the first voltage may be 24 V, the second voltage may be 21 V, and the rated voltage of the power tool 200 may be 18 V.

The voltage conversion unit 310 includes a switch unit 311, a capacitor C, and a control unit 320. The switch unit 311 is connected between the first port 301 and the second port 302 and is electrically connected to the control unit 320. The capacitor C is connected in parallel to the second port 302, and the capacitance value of the capacitor C is greater than or equal to 470 μF*2 and less than or equal to 680 μF*4. Optionally, the capacitor C may be a ceramic capacitor. Optionally, the capacitor C may be an aluminum electrolytic capacitor. Optionally, the capacitor C may be a plastic capacitor. In addition, the capacitor C may also be any type of capacitor with a capacitance value range of 470 μF*2 to 680 μF*4, which is not limited in the present application.

The control unit 320 sets the switching frequency or switching duty cycle of the switch unit 311 based on the parameter related to the current of a motor 210 of the power tool 200 so that based on the switching frequency or switching duty cycle of the switch unit 311, the voltage conversion unit 310 converts the first voltage outputted by the battery pack 100 into the second voltage used by the power tool 200. Optionally, the switch unit 311 is a MOS transistor. Optionally, the switch unit 311 is a triode. The case where the switch unit 311 is the MOS transistor is used as an example for a specific description in the present application. Optionally, the switch unit 311 may be a P-channel enhancement-mode MOS transistor. Optionally, the switch unit 311 may be a P-channel depletion-mode MOS transistor. Optionally, the switch unit 311 may be an N-channel enhancement-mode MOS transistor. Optionally, the switch unit 311 may be an N-channel depletion-mode MOS transistor. In addition, compared with the existing voltage step-down circuit such as a buck circuit, the voltage conversion unit 310 in the present application does not require components such as inductors to buck the voltage, thereby reducing the size of the adapter 300 and saving the cost of the adapter 300.

The voltage conversion performed by the control unit 320 is specifically shown in FIG. 4. The control unit 320 includes a control module 321, and the control module 321 includes a first input terminal 3211, a second input terminal 3212, and an output terminal 3213. The first input terminal 3211 is used for receiving a reference voltage, the second input terminal 3212 is used for receiving a real-time voltage across two ends of the capacitor C (that is, the current output voltage of the adapter 300), and the output terminal 3213 is electrically connected to the switch unit 311 and is used for outputting control information to the switch unit 311. The control module 321 sets the switching frequency or switching duty cycle of the switch unit 311 based on the difference between the reference voltage and the current output voltage of the adapter 300 to update the output voltage of the adapter 300 such that the output voltage of the adapter 300 is basically the same as the reference voltage. The reference voltage is a voltage value preset based on the rated voltage of the power tool 200, that is, the reference voltage is determined based on the second voltage outputted by the second port 302. For example, the reference voltage may be 21 V. After the adapter 300 updates the output voltage once, that is, the output voltage at this time can be used by the power tool 200, the output voltage of the adapter 300 at this time is the second voltage. Subsequently, the control module 321 repeatedly compares the second voltage with the reference voltage to set the switching frequency or switching duty cycle of the switch unit 311 such that the second voltage is basically the same as the reference voltage. Optionally, the control module 321 may be a PI control module.

As shown in FIG. 3, the adapter 300 further includes a current detection unit 330 electrically connected to the motor 210 and used for detecting the bus current or operating current of the motor 210. The second voltage varies with the bus current. The greater the bus current is, the greater the second voltage is. The current detection unit 330 is also electrically connected to the control unit 320 and used for transmitting the bus current of the motor 210 to the control unit 320. In addition, when the current detection unit 300 detects the operating current of the motor 210, a corresponding conversion relationship exists between the operating current and the bus current, and the operating current may be converted into a corresponding bus current according to the conversion relationship between the operating current and the bus current for subsequent operations.

When the control unit 320 detects that the bus current is greater than or equal to the preset current threshold, the control unit 320 sets the duty cycle of the switch unit 311 to 1, the switch unit 311 is always on, and the adapter 300 does not buck the first voltage outputted by the battery pack 100 and directly supplies the power tool 200 with the first voltage. When the power tool 200 is under a relatively heavy load, the bus current of the motor 210 is greater than or equal to the preset current threshold, and the greater the bus current is, the greater the second voltage required by the power tool 200 is. Therefore, there is no need to buck the first voltage, the second voltage is equal to the first voltage and is supplied to the power tool 200, and the rotational speed of the power tool 200 is within a suitable range. Moreover, since the switch unit 311 is always on, the loss of the MOS transistor is small, the capacitor C is continuously in a charged state, and the ripple current of the capacitor C is small so that the temperature rise of the switch unit 311 and the capacitor C is small, thereby solving the problem of severe heating of the adapter 300. The preset current threshold is approximately 17 A.

When the control unit 320 detects that the bus current is less than the preset current threshold, to prevent the maximum rotational speed of the power tool 200 from exceeding the maximum nominal rated rotational speed too much, the control unit 320 needs to bucks the first voltage to the second voltage. The specific process of the voltage step-down by the control unit 320 is described above in the present application, and the details are not repeated here. When the control unit 320 performs the voltage step-down, the control unit 320 sets the switching duty cycle of the switch unit 311 to be less than 1. In the case where the power tool 200 is under no load or under a low load, the bus current of the power tool 200 is relatively small, and the second voltage is also relatively small. In this case, to buck the first voltage to the second voltage, the switching duty cycle of the switch unit 311 is relatively small so that the switching frequency of the switch unit 311 is relatively high. In this case, since the switching frequency of the switch unit 311 is relatively high, the MOS transistor has a large loss and generates a significant amount of heat, the capacitor C is repeatedly charged and discharged, and the capacitor C has a large ripple current and generates a significant amount of heat. As a result, the overall temperature rise of the adapter 300 is large, and there is a probability that the temperature rise exceeds the standard.

As shown in FIG. 4, the adapter 300 further includes a correction unit 340. The correction unit 340 is connected to the first input terminal 3211 of the control module 321. After acquiring the parameter of the motor 210, the correction unit 340 outputs a correction value to correct the reference voltage. The correction value includes the current compensation feedback I_{bus}*R*K, where the current compensation feedback is a parameter related to the current of the motor 210. The parameter related to the current of the motor 210 includes the bus current I_{bus} of the motor 210, loop impedance R, and a compensation coefficient K. The loop impedance R is the impedance of the loop between the battery pack 100 and the motor 210 of the power tool 200, and the compensation coefficient K is a constant greater than 0 determined based on empirical values.

In some examples, the control module 321 adjusts the switching duty cycle of the switch unit 311 based on the corrected reference voltage and the second voltage. Specifically, the control module 321 sets the switching duty cycle based on the difference between the sum of the current compensation feedback I_{bus}*R*K and the reference voltage and the current second voltage so that the second voltage is basically the same as the sum of I_{bus}*R*K and the reference voltage. In the case where the bus current remains unchanged, the second voltage increases so that the switching duty cycle of the switch unit 311 increases. Compared with the switching duty cycle directly set based on the difference between the reference voltage and the current second voltage without setting the current compensation feedback, the switching duty cycle set based on the difference between the sum of the current compensation feedback I_{bus}*R*K and the reference voltage and the current second voltage is greater. Therefore, the switching frequency of the switch unit 311 is reduced, the loss of the MOS transistor is reduced, and the temperature rise is reduced so that the charging and discharging frequency of the capacitor C is reduced, the ripple current of the capacitor C becomes smaller, the heating of the capacitor C is alleviated, and the temperature rise of the adapter 300 is alleviated, thereby increasing the probability that the temperature rise result of the adapter 300 is within a suitable range.

In some examples, after the power tool 200 is started up, the adapter 300 needs to promptly convert the first voltage outputted by the battery pack 100 into the second voltage and supply the second voltage to the power tool 200. In this case, the adapter 300 needs to be powered on promptly to charge the capacitor C for supplying power, thereby preventing the power tool 200 from entering a low-voltage state and failing to start or from triggering the undervoltage protection. When the voltage across two ends of the capacitor C is less than a preset voltage threshold, the adapter 300 can be powered on promptly after the battery pack 100 is combined with the adapter 300. When the voltage across two ends of the capacitor C is greater than or equal to the preset voltage threshold or the capacitor C is fully charged, the adapter 300 may be difficult to power on promptly. The preset voltage threshold is 13 V.

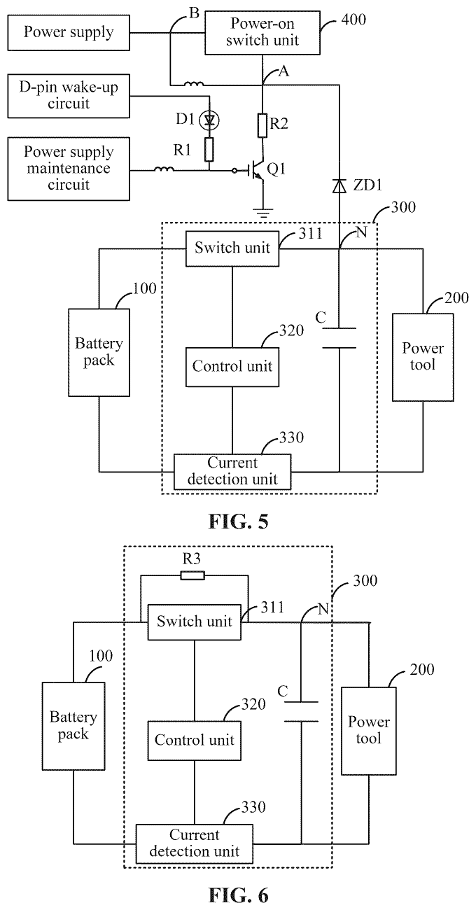

In some examples, FIG. 5 is a circuit connection diagram in which the adapter 300 is controlled to power on the power tool 200 promptly. The condition for the adapter 300 to be powered on promptly to charge the capacitor C is that a power-on switch unit 400 is in an on state. As shown in FIG. 5, when the voltage at point A in FIG. 5 is lower than the voltage at point B, that is, when the power-on switch unit 400 is in a negative voltage state, the power-on switch unit 400 is turned on.

When the battery pack 100 is first combined with the adapter 300, the capacitor C has not been charged, the voltage across two ends of the capacitor C is less than the preset voltage threshold, and the voltage at point N where the capacitor C is connected to the Zener diode ZD1 is a lower voltage so that the voltage at point A is also a lower voltage, the voltage at point A is lower than the voltage at point B, the power-on switch unit 400 is turned on, the capacitor C is charged promptly, and the adapter 300 is powered on promptly.

When the capacitor C is fully charged or the voltage across two ends of the capacitor C is greater than or equal to the preset voltage threshold, the voltage at point N where the capacitor C is connected to the Zener diode ZD1 is a higher voltage. In this case, the power-on switch unit 400 can no longer be turned on through the loop of the Zener diode ZD1. As shown in FIG. 5, the power-on circuit diagram further includes a D-pin wake-up circuit, a power supply maintenance circuit, a diode D1, a resistor R1, a transistor Q1, and a resistor R2, and the diode D1 is electrically connected to the resistor R1. The resistor R1 is used for limiting the current to prevent the diode D1 from being broken down due to overheating caused by an excessive current. In this case, the pin of the D-pin wake-up circuit is pulled high so that the diode D1 is turned on and the transistor Q1 is turned on. After the transistor Q1 is turned on, the voltage is divided across the resistor R2. In this case, the voltage at point A is less than the voltage at point B so that the power-on switch unit 400 is turned on. After the power-on switch unit 400 is turned on, the power supply maintenance circuit keeps the transistor Q1 turned on continuously. In this manner, the power-on switch unit 400 is turned on continuously so that the adapter 300 can continuously power on the power tool 200.

By setting up the power-on circuit including the D-pin wake-up circuit, the power supply maintenance circuit, the diode D1, and the transistor Q1, no matter how large the voltage of the capacitor C is or whether the capacitor C is fully charged, the adapter 300 can be powered on promptly to supply power to the power tool 200. Moreover, there is no need to use an additional button structure to activate the power-on of the adapter 300, thereby improving the convenience of the adapter 300.

In some examples, as shown in FIG. 6, a resistor R3 is connected in parallel across two ends of the switch unit 311. By providing the resistor R3, there is always a current flowing through the capacitor C so that the capacitor C can be kept in the charged state. In this manner, when the battery pack 100 is combined with the adapter 300, the power tool 200 can be used continuously.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A power tool system, comprising:
a power tool having a motor;
a battery pack configured to be capable of outputting a voltage different from a rated voltage of the power tool to start the power tool; and
an adapter, electrically connected between the power tool and the battery pack, comprising a first port electrically connectable to the battery pack and used for accessing a first voltage outputted by the battery pack, a second port electrically connectable to the power tool and used for outputting a second voltage, and a voltage conversion unit, for converting the first voltage into the second voltage, comprising a switch unit connected between the first port and the second port, a capacitor connected in parallel to the second port, and a control unit configured to set a switching frequency or a switching duty cycle of the switch unit based on at least a parameter related to a current of the motor.

2. The power tool system of claim 1, further comprising a current detection unit for detecting a bus current of the motor, wherein the control unit sets the switching duty cycle to 1 when detecting that the bus current is greater than or equal to a preset current threshold.

3. The power tool system of claim 2, wherein the current detection unit is further used for detecting an operating current of the motor, and a corresponding conversion relationship exists between the operating current and the bus current.

4. The power tool system of claim 2, wherein the preset current threshold is approximately 17 A.

5. The power tool system of claim 1, wherein the parameter comprises I_{bus}, R, and K, I_{bus} denotes a bus current of the motor, R denotes loop impedance, and K denotes a constant greater than 0.

6. The power tool system of claim 5, wherein the control unit further comprises a correction unit, the correction unit acquires the parameter and outputs a correction value to correct a reference voltage, and the correction value comprises a current compensation feedback I_{bus}*R*K.

7. The power tool system of claim 5, wherein the loop impedance is impedance of a loop between the battery pack and the motor of the power tool.

8. The power tool system of claim 6, wherein the control unit is configured to set the switching duty cycle based on a difference between a sum of the current compensation feedback and the reference voltage and a current second voltage such that the second voltage is basically the same as the sum.

9. The power tool system of claim 2, wherein the second voltage varies with the bus current.

10. The power tool system of claim 1, wherein the first voltage is greater than the second voltage, and the second voltage is greater than the rated voltage of the power tool.

11. The power tool system of claim 1, wherein a capacitance value of the capacitor is greater than or equal to 470 μF*2 and less than or equal to 680 μF*4.

12. The power tool system of claim 1, wherein the switch unit is a metal-oxide-semiconductor (MOS) transistor or a triode.

13. The power tool system of claim 1, wherein the control unit comprises a control module, and the control module is a proportional-integral (PI) control module.

14. The power tool system of claim 1, further comprising a power-on switch unit, wherein when the power-on switch unit is turned on, the adapter is powered on to charge the capacitor.

15. The power tool system of claim 1, wherein a resistor is connected in parallel across two ends of the switch unit to keep the capacitor in a charged state.

16. A power tool system, comprising:
a power tool having a motor;
a battery pack configured to be capable of outputting a voltage different from a rated voltage of the power tool to start the power tool; and
an adapter, electrically connected between the power tool and the battery pack, comprising a first port electrically connectable to the battery pack and used for accessing a first voltage outputted by the battery pack, a second port electrically connectable to the power tool and used for outputting a second voltage, and a voltage conversion unit, for converting the first voltage into the second voltage to supply power to the power tool, comprising a switch unit connected between the first port and the second port and a control unit having a first input terminal for accessing a reference voltage, a second input terminal for accessing the second voltage, an output terminal connected to the switch unit, and a correction unit for acquiring a parameter output a correction value of the motor to correct the reference voltage;
wherein the control unit is configured to adjust a switching duty cycle of the switch unit based on the corrected reference voltage and the second voltage.

17. An adapter, comprising:
a first port electrically connectable to a battery pack and used for accessing a first voltage outputted by the battery pack;
a second port electrically connectable to a power tool and used for outputting a second voltage to supply power to a motor of the power tool; and
a voltage conversion unit, for converting the first voltage into the second voltage with the first voltage being greater than or equal to the second voltage, comprising a switch unit connected between the first port and the second port and a control unit configured to set a switching duty cycle of the switch unit to 1 when a current of the motor reaches a preset current threshold and set the switching duty cycle of the switch unit to be less than 1 when the current of the motor is less than the preset current threshold.

18. The adapter of claim 17, wherein the preset current threshold is approximately 17 A.

19. The adapter of claim 17, wherein the control unit further comprises a correction unit, the correction unit acquires a parameter of the motor and outputs a correction value to correct a reference voltage, and the correction value comprises a current compensation feedback I_{bus}*R*K, wherein I_{bus} denotes a bus current of the motor, R denotes loop impedance, and K denotes a constant greater than 0.

20. The adapter of claim 19, wherein when the current of the motor is less than the preset current threshold, the control unit is configured to set the switching duty cycle based on a difference between a sum of the current compensation feedback and the reference voltage and a current second voltage such that the second voltage is basically the same as the sum.
